(19) United States
(12) Patent Application Publication
(10) Pub. No.: US 2023/0410777 A1
(43) Pub. Date: Dec. 21, 2023

(54) CASE AND KEYBOARD INSTRUMENT

(71) Applicant: CASIO COMPUTER CO., LTD., Tokyo (JP)

(72) Inventors: Hirokatsu KATOH, Kawasaki-shi (JP); Takahiro MORIYA, Tokyo (JP)

(73) Assignee: CASIO COMPUTER CO., LTD., Tokyo (JP)

(21) Appl. No.: 18/205,354

(22) Filed: Jun. 2, 2023

(30) Foreign Application Priority Data
Jun. 21, 2022 (JP) 2022-099317

(51) Int. Cl. G10H 1/32

(52) U.S. Cl. CPC G10H 1/32; G10H 2220/221

(57) ABSTRACT

A case includes an exterior member including a first surface including an external surface of a first sheet and a second surface connected to the first surface, and an attachment member to which the exterior member is attached, having a facing surface disposed to face the second surface, and arranged in such a manner that a projecting end of the facing surface projects further than the first surface when viewed in cross section.

### CROSS-REFERENCE TO RELATED APPLICATION

This patent application is based upon and claims the benefit of priority under 35 USC 119 of Japanese Patent Application No. 2022-099317 filed on Jun. 21, 2022, the entire disclosure of which, including the specification, claims, drawings and abstract, is incorporated herein by reference in its entirety.

### BACKGROUND

### Technical Field

The present disclosure relates to a case and a keyboard instrument.

### Description of the Related Art

There have conventionally been provided cases for keyboard instruments or the like which include an exterior member to which a sheet of material for decorating or protecting an inner member is affixed. For example, Japanese Unexamined Patent Application Publication No. 2010-60983 (JP-A-2010-60983) discloses a keyboard instrument including legs each having, as one side plate thereof, a member made up of two plate materials which are each covered with a sheet material whose end portions are folded on to an internal surface so as to cover from an external surface to external edge faces of the plate material and whose internal surfaces are affixed together. This configuration prevents the end portions of the sheet material from being exposed from an external surface of the member, thereby making it possible to reduce a risk of the sheet material being peeled off from the end portions thereof.

### SUMMARY

According to an aspect of the present disclosure, there is provided a case including an exterior member including a first surface including an external surface of a first sheet and a second surface connected to the first surface, and an attachment member to which the exterior member is attached, having a facing surface disposed to face the second surface, and arranged in such a manner that a projecting end of the facing surface projects further than the first surface when viewed in cross section.

According to another aspect of the present disclosure, there is provided a keyboard instrument comprising a keyboard and the case which is disposed as an arm of the keyboard. The case is arranged so that the exterior member and the attachment member are disposed at a side of the keyboard.

### BRIEF DESCRIPTION OF THE DRAWINGS

FIG. 1 is a perspective view showing a keyboard instrument including a case according to an embodiment of the present disclosure;

FIG. 2A is an upper front perspective view showing the vicinity of a right-hand side case of the keyboard instrument according to the embodiment of the present disclosure, FIG. 2B is a sectional view taken along a line B-B in FIG. 2A, FIG. 2C is a sectional view taken along a line C-C in FIG. 2A, FIG. 2D is a sectional view taken along a line D-D in FIG. 2A, and FIG. 2E is a sectional view taken along a line E-E in FIG. 2A;

FIG. 3A is a lower back perspective view showing the vicinity of the right-hand side case of the keyboard instrument according to the embodiment of the present disclosure, FIG. 3B is a sectional view taken along a line B-B in FIG. 3A, and FIG. 3C is a sectional view taken along a line C-C in FIG. 3A;

FIG. 4 is an exploded perspective view of the right-hand side case of the keyboard instrument according to the embodiment of the present disclosure;

FIG. 5 is an exploded perspective view showing an exterior member main body and sheets which are affixed to the exterior member main body for the right-hand side case of the keyboard instrument according to the embodiment of the present disclosure as viewed from an internal surface side thereof;

FIG. 6 is a perspective view of an exterior member for the right-hand side case of the keyboard instrument according to the embodiment of the present disclosure as viewed from an internal surface side thereof;

FIG. 7 is a perspective view of an attachment member for the right-hand side case of the keyboard instrument according to the embodiment of the present disclosure as viewed from the back thereof; and

FIG. 8 is a sectional view of the right-hand side case of the keyboard instrument according to the embodiment of the present disclosure which corresponds to a section taken along a line VIII-VIII in FIG. 7.

### DESCRIPTION OF THE EMBODIMENT

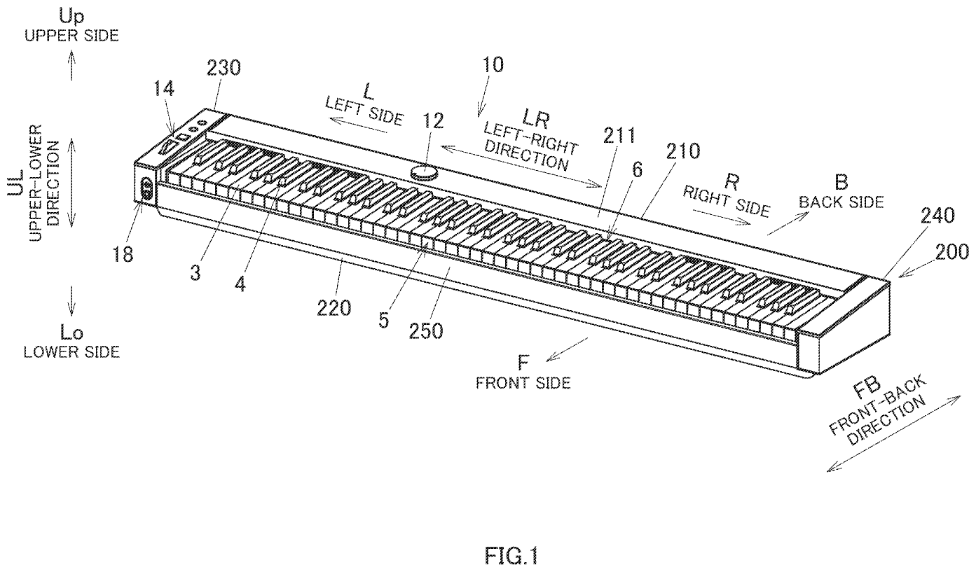

Hereinafter, an embodiment of the present disclosure will be described based on drawings. A keyboard instrument shown as an electronic piano in FIG. 1 includes a full-scale (88-note) keyboard 5 including plural white keys 3 and plural black keys 4, which make up 88 keys of the keyboard and a case 200. In the following description, in the electronic keyboard instrument 10, a front side (a near side) of the keys in the keyboard 5 in a front-back direction FB is referred to as a front side F, and a back side (a far side) of the keys in the front-back direction FB is referred to as a back side B. When facing the keyboard 5 from the front side F, a left of the keyboard 5 is referred to as a left side L, and a right of the keyboard 5 is referred to as a right side R. In the keyboard 5, a direction in which the keys are aligned is referred to as a left-right direction. In an up-down direction of the keyboard instrument 10, an upper side is referred to as an upper side Up, while a lower side is referred to as a lower side LO. In the present embodiment, while the keyboard instrument 10 is described as an electronic piano, the present disclosure may be applied to any other keyboard instruments. In addition, the present embodiment will also describe a case for the keyboard instrument 10; however, the present embodiment may also be applied to a case for a device such as other electronic equipment.

As shown in FIG. 1, the case 200 has an upper case 210, a lower case 220, a left-hand side case 230 and a right-hand side case 240, a plate-shaped front case 250, and a back panel 260 which connects to the upper case 210. The upper case 210, the lower case 220, and the front case 250 are provided long in the left-right direction LR. The front case 250 is provided between the left-hand side case 230 and the right-hand side case 240 on the front side F of the keyboard 5. The left-hand side case 230 and the right-hand side case 240 (an exterior member 100 and an attachment member 300 which will be described later) are arms which are provided at sides of the keyboard 5. In the embodiment, “connect” means a state which are adjacent to each other by physical contact.

A plate-shaped upper panel 211 is provided on an upper surface side of the upper case 210. The left-hand side case 230, which is long in the front-back direction FB and has a substantially rectangular shape when viewed from above, is disposed in such a manner as to lie adjacent to a left end portion of the upper case 210 and a left end portion of the front case 250. The right-hand side case 240, which has a substantially rectangular shape as with the left-hand side case 230, is disposed in such a manner as to lie adjacent to a right end portion of the upper case 210 and a right end portion of the front case 250. The lower case 220 is provided on a lower side Lo of the upper case 210, the left-hand side case 230, and the right-hand side case 240.

A controller 14 including a pitch bender, push buttons, and the like is provided on an upper surface of the left-hand side case 230. An earphone jack 18 is provided in a front surface of the left-hand side case 230. Additionally, a volume controlling rotary-type rotational knob 12 is provided on the upper panel 211 of the upper case 210.

Next, the side cases (the left-hand side case 230, the right-hand side case 240) will be described. Here, the left-hand side case 230 is substantially laterally symmetrical with the right-hand side case 240 excluding the attachment structures of the controller 14 and the earphone jack 18 and has substantially the same case structure as that of the right-hand side case 240, and hence, the right-hand side case 240 will be described by giving attention thereto.

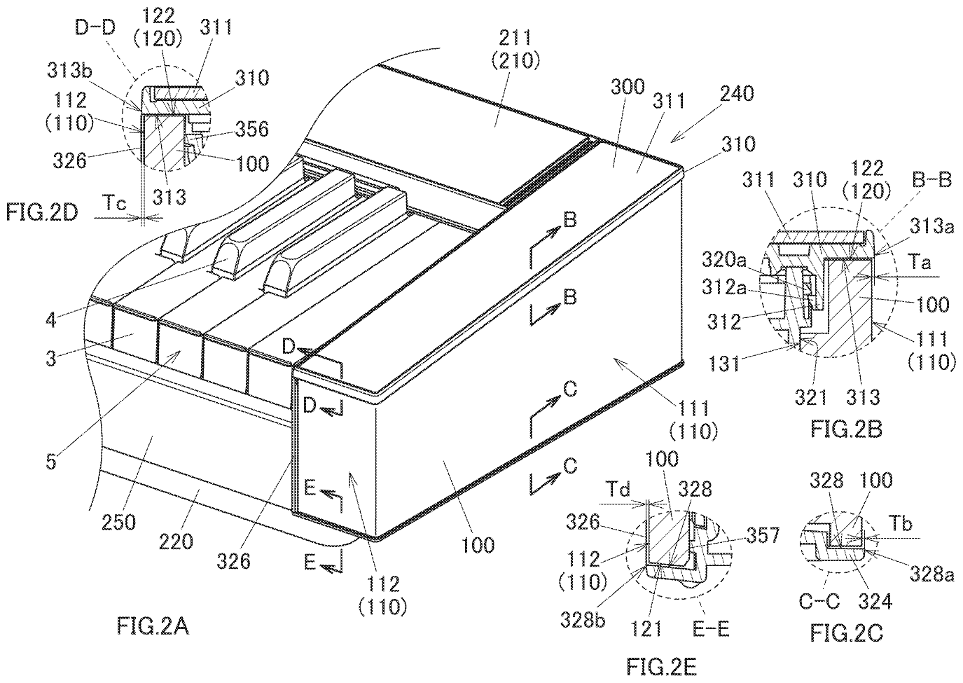

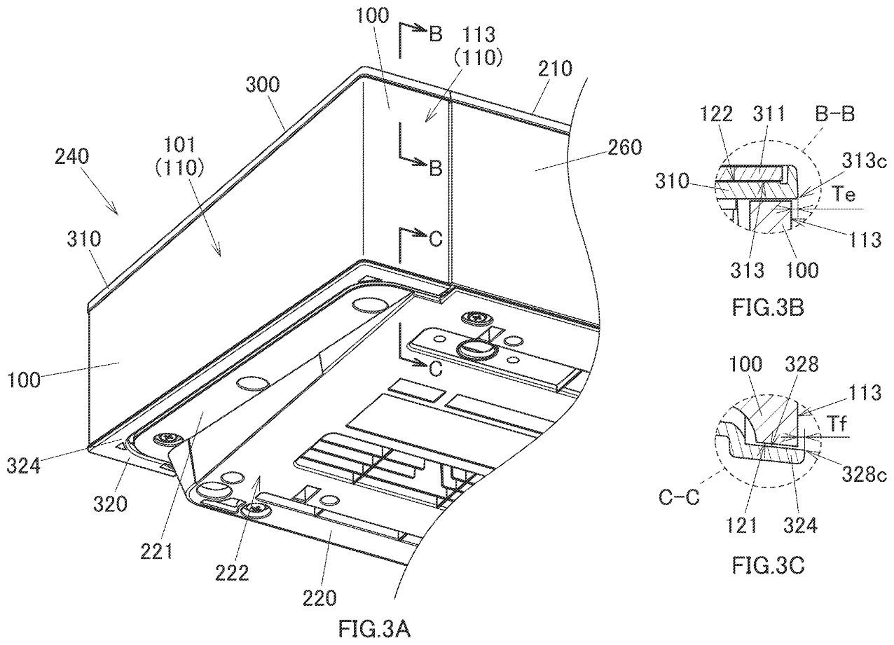

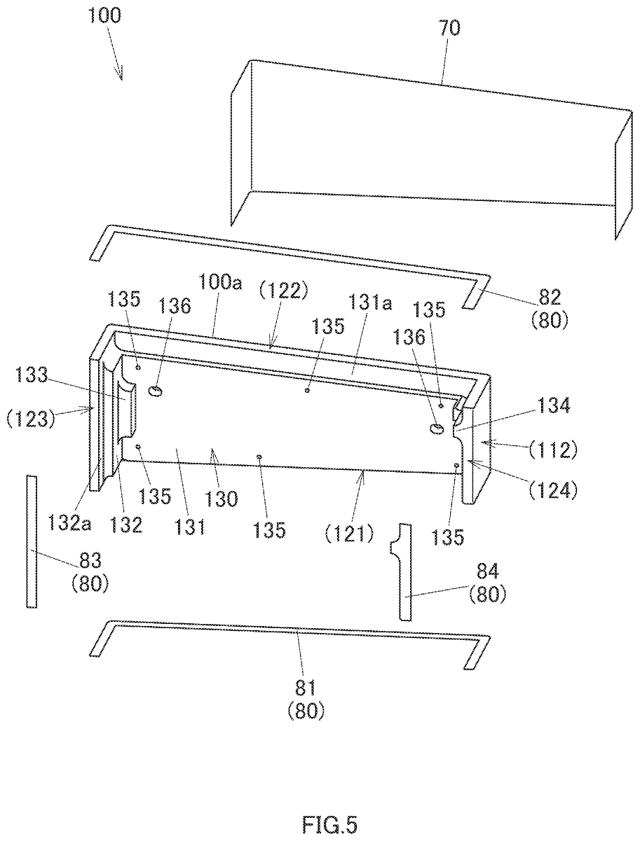

As shown in FIGS. 2A and 3A, the right-hand side case 240 includes the exterior member 100 and the attachment member 300 to which the exterior member 100 is attached. Although the exterior member 100 will be described in detail by reference to FIG. 5, one first sheet 70 and plural second sheets 80 are affixed to an exterior member main body 100a. In the present embodiment, the exterior member main body 100a is made up of a medium density fiberboard (MDF). The first sheet 70 and the second sheets 80 are made up of a sheet material in which a pseudo-wood printing or the like is applied to an external surface (a surface that the user can see), which is one of internal and external surfaces, and an adhesive layer is provided on the other surface.

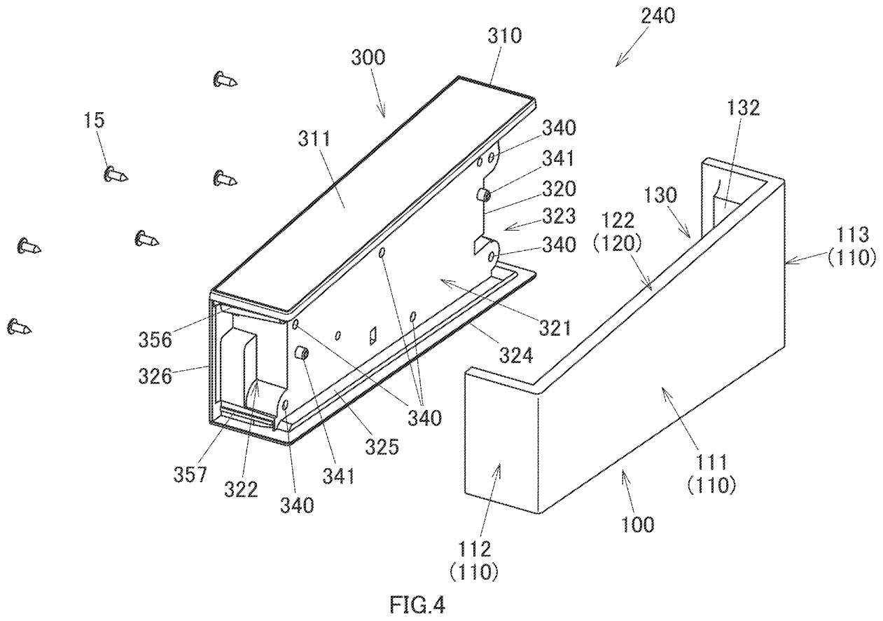

As shown in FIG. 4, the exterior member 100 (the exterior member main body 100a) has substantially a U-shape when seen from above and is provided in such a manner that a height in the up-down direction gradually reduces from the front to the back. The exterior member 100 has a side surface 111, a front surface 112 which connects to a front end of the side surface 111, and a back surface 113 which connects to a back end of the side surface 111. Connecting corners between the side surface 111 and the front surface 112 and between the side surface 111 and the back surface 113 are formed into a small roundly chamfered corner. The side surface 111, the front surface 112, and the back surface 113 constitute a first exterior surface 110 (a first surface) which is an external surface becoming visible in such a state that the exterior member 100 is attached to the attachment member 300. The side surface 111, the front surface 112, and the back surface 113 of the exterior member 100 may be formed from the same material into an integrated unit or may be separate members which are joined together.

An internal surface 130 of the exterior member main body 100a (the exterior member 100) constitutes an internal surface which faces the first exterior surface 110, and this internal surface is a surface becoming invisible in such a state that the exterior member 100 is attached to the attachment member 300.

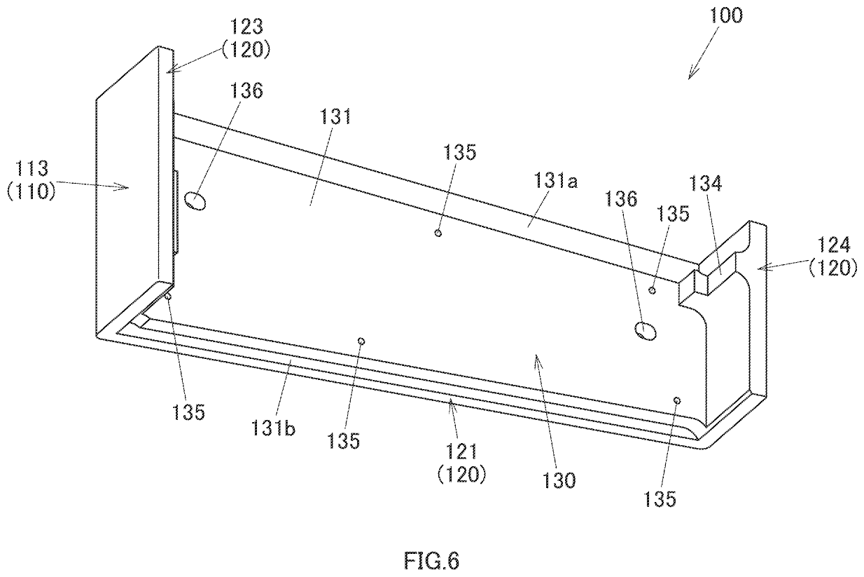

A surface which connects the first exterior surface 110 and the internal surface 130 together is referred to as a second exterior surface 120 (a second surface). The second exterior surface 120 becomes slightly visible from a gap from time to time in such a state that the exterior member 100 is attached to the attachment member 300 and is hence referred to as an external surface. The second exterior surface 120 corresponds to a cut end of a plate material. The second exterior surface 120 has a lower surface 121 shown in FIG. 6, an upper surface 122 (refer to FIG. 4), and a back surface 123 on a back side and a front surface 124 which are individually provided in such a manner as to connect the lower surface 121 and the upper surface 122 together.

As shown in FIGS. 4, 5, the first sheet 70 is made up of a single sheet which is provided into a shape following surfaces of the exterior member main body 100a which correspond to the side surface 111, the front surface 112, and the back surface 113 of the exterior member 100. Here, the first exterior surface 110 includes an external surface of the first sheet 70 which is affixed to the exterior member main body 100a.

The plural second sheets 80 are each made up of a single sheet which is shaped to follow one of the individual surfaces of the second exterior surface 120. Here, the second exterior surface 120 includes external surfaces of the second sheets 80 which are affixed to the exterior member main body 100a.

A lower surface sheet 81 is affixed to a surface of the exterior member main body 100a which corresponds to the lower surface 121 of the exterior member 100, and an upper surface sheet 82 is affixed to a surface of the exterior member main body 100a which corresponds to the upper surface 122 of the exterior member 100. A back surface sheet 83 is affixed to a surface of the exterior member main body 100a which corresponds to the back surface 123 of the exterior member 100, and a front surface sheet 84 is affixed to a surface of the exterior member main body 100a which corresponds to the front surface 124 of the exterior member 100. Here, the back surface sheet 83 and the front surface sheet 84 may be integrated into the first sheet 70 before affixation.

In this way, the exterior member 100 is made up by affixing the sheets (the first sheet 70, the second sheet to the exterior member main body 100a. In other words, the sheets (the first sheet 70, the second sheet 80) are affixed to the other surfaces than the internal surface 130 of the exterior member 100. That is, the first sheet 70 is a sheet that is affixed to the wide surface which can be seen from an exterior location, and the second sheet 80 is a sheet that is affixed to the cut end portions of the plate material which are hardly visible from the exterior location.

As shown in FIG. 6, a projecting flat portion 131 as a surface which projects an inward direction (a direction towards the left side L on the right-hand side case 240, a direction towards the right side R on the left-hand side case 230) is provided on the internal surface 130 which corresponds to the side surface 111 (refer to FIG. 4) of the exterior member 100. Step portions 131a, 131b are provided along an edge on the upper side Up and an edge on the lower side Lo, respectively, of the projecting flat portion 131. Six screw prepared holes 135 and two elliptical guide holes 136 which are long in the front-back direction FB are provided in the projecting flat portion 131.

As shown in FIG. 5, a projecting flat portion 132 as a surface projecting to the front is provided on the internal surface 130 which corresponds to the back surface 113. A step portion 132a is provided along an internal edge of the projecting flat portion 132.

A vertically long, substantially rectangular parallelepiped projection 133 is provided at a connecting portion where the projecting flat portions 131, 132 are connected together. Additionally, as shown in FIG. 6, a laterally long, substantially rectangular parallelepiped projection 134 is provided on the internal surface 130 which corresponds to the front surface 112. A proximal portion of the projection 134 is largely roundly chamfered towards the front surface 124, and hence, the front surface 124 has a shape in which a side surface portion of the projection 134 having a curved surface is connected to a rectangular portion. As a result, the front surface sheet 84 is set to a shape similar to that of the front surface 124.

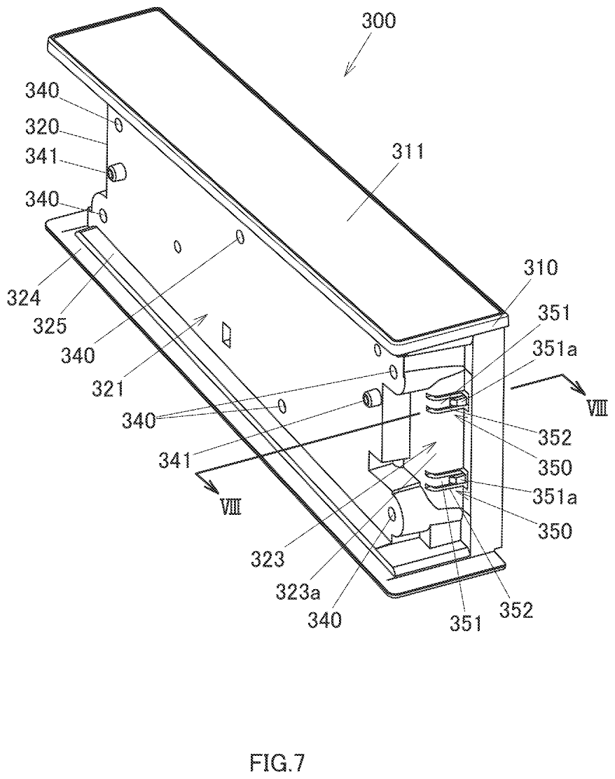

As shown in FIGS. 4 and 7, the attachment member 300 is formed into a substantially rectangular parallelepiped shape which is long in the front-back direction FB and has a top plate 310 and a main body 320. The top plate 310 is formed substantially into an elongated rectangular plate shape which is long in the front-back direction FB and is provided at an upper end portion of the main body 320. An upper panel 311 is placed to be attached to an upper surface of the top plate 310. The top plate 310 and the main body 320 are fixed to each other with screws (not shown). These screws are provided on the upper surface of the top plate 310 which is covered with the upper panel 311.

As shown in FIG. 2B which is a sectional view taken along a line B-B in FIG. 2A, a vertical plate 312 which is long in the front-back direction FB is provided on a lower surface of the top plate 310. The top plate 310 is reinforced so as not to be separated from the main body 320 through engagement of plural wedge-shaped engagement portions 312a which are provided on the vertical plate 312 with a wedge-shaped engagement portion 320a which is provided long in the front-back direction FB on an upper portion of the main body 320. In addition, the vertical plate 312 is provided in such a manner as to face the internal surface 130 which corresponds to the side surface 111.

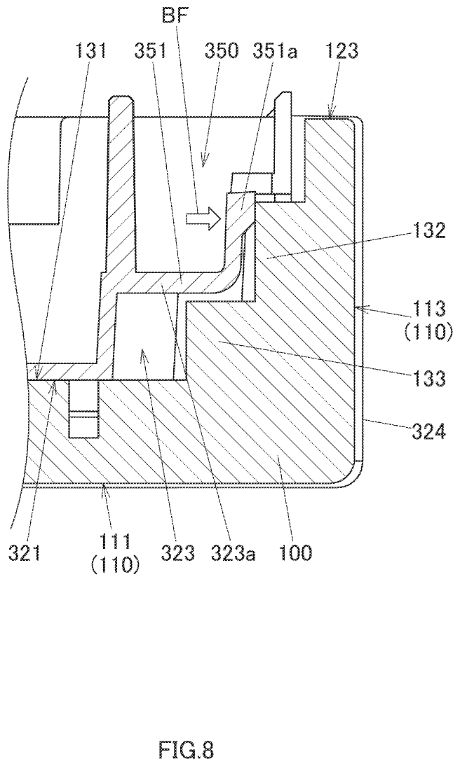

Referring to FIG. 4, the main body 320 is a member which is formed from a resin material into an integrated unit. An internal side surface 321 of the main body 320 is provided substantially into a flat surface which is vertical to a horizontal plane. In the right-hand side case 240, the side surface 321 is in abutment with the projecting flat portion 131 of the internal surface 130 which corresponds to the side surface 111 of the exterior member 100 (refer to FIG. 2B and 8).

Concave and convex shapes are provided on a front portion 322 (refer to FIG. 4) and a back portion 323 (refer to FIG. 7) of the main body 320 as required. The projection 134 of the exterior member 100 is disposed in such a manner as to face a concave portion of the front portion 322, and the projection 133 of the exterior member 100 is disposed in such a manner as to face a concave portion of the back portion 323.

As shown in FIG. 4, abutment ribs 356, 357 which are long in the left-right direction LR are provided respectively on an upper side and a lower side of the front portion 322 of the main body 320. As shown in FIG. 2D which is a sectional view taken along a line D-D in FIG. 2A and FIG. 2E which is a sectional view taken along a line E-E in FIG. 2A, the upper abutment rib 256 and the lower abutment rib 257 are in abutment with the internal surface 130 which corresponds to the front surface 112 of the exterior member 100.

As shown in FIGS. 4 and 7, a substantially U-shaped bottom plate 324 is provided on a lower side of the front portion 322, the side surface 321, and the back portion 323 of the main body 320 in such a manner as to project along the front portion 322, the side surface 321, and the back portion 323. The front portion 322, the side surface 321, and the back portion which lie between a lower surface 313 of the top plate 310 and an upper surface 328 (refer to FIGS. 2B to 2E) of the bottom plate 324 are formed substantially into a recessed shape, so that the exterior member 100 can be disposed therein.

Six screw holes 340 are provided in the side surface 321 of the main body 320. Wood screws 15 are screwed into the screw prepared holes 135 in the exterior member 100 via the screw wholes 340, whereby the exterior member 100 is attached to the attachment member 300. Here, the exterior member 100 is biased to the back by a biassing mechanism 350, which will be described later. As a result, the exterior member 100 is fastened to the attachment member 300 with the screws in a direction which is perpendicular to a direction in which the exterior member 100 is biased (a backward direction). In addition, two pins 341 provided on the side surface 321 of the main body 320 are inserted individually into the two guide holes 136 in the exterior member 100 before the screw fastening step, whereby the exterior member 100 is positioned properly in the up-down direction relative to the attachment member 300 (the main body 320).

A substantially thin plate-shaped step 325 is provided at a connecting portion between the side surface 321 of the main body 320 and the bottom plate 324 in such a manner as to extend substantially over a full length of the side surface 321 in a front-back direction thereof.

A substantially plate-shaped boundary plate 326 is provided in such a manner as to extend between the bottom plate 324 and the top plate 310 on a side of the front portion 322 which faces the keyboard 5 (an internal side).

Referring to FIG. 3A, the attachment member 300 is provided in such a manner that a length between the top plate 310 and the bottom plate 324 gradually reduces towards the front. As a result, when the top plate 310 is disposed horizontally, the bottom plate 324 is disposed inclined in such a manner as to climb up towards the front. A lower surface of the bottom plate 324 of the attachment member 300 is fixed to a connection plate 221 which is provided in such a manner as to protrude from a side of the lower case 220. The connection plate 221 of the lower case 220 is caused to incline in such a manner as to climb up towards the front. As result, when the keyboard instrument 10 is placed, a lower surface 222 of the lower case 220 is made substantially parallel to the upper panel 311 of the top plate 310.

In addition, as shown in FIG. 7, two vertically positioned biasing mechanisms 350 are provided at the back portion 323 of the attachment member 300 in such a manner as to be integrated with the attachment member 300. A plate spring (an elastic member) 351, which is a substantially plate-shaped resin spring, is provided on the biasing mechanism 350. The plate spring 351 is provided at a base portion 323a which connects to the side surface 321 at the rear portion 323, and a substantially U-shaped slit 352 is provided on an outer circumference of the plate spring 351. An abutment projection 351a is provided at a projecting end of the plate spring 351 in such a manner as to project to the back.

In attaching the exterior member 100 to the attachment member 300, the exterior member 100 is inserted between the top plate 310 and the bottom plate 324 of the recessed attachment member 300 in such a manner as to fit an opening side of the substantially U-shaped exterior member 100 in the space defined between the top plate 310 and the bottom plate 324. As this occurs, the internal surface 130 of the exterior member 100 which corresponds the front surface 112 are brought into abutment with the abutment ribs 356, 357 as shown in FIG. 2D which is the sectional view taken along the line D-D in FIG. 2A and FIG. 2E which is the sectional view taken along the line E-E in FIG. 2A. Additionally, the projecting flat portion 131 of the internal surface 130 which corresponds to the side surface 111 is brought into abutment with the side surface 321 as shown in FIGS. 2B and 8, and the projecting flat portion 132 of the internal surface 130 which corresponds to the back surface 133 is brought into abutment with the abutment projection 351a of the biasing mechanism 350 as shown in FIG. 8. Then, the biasing mechanism 350 generates a biasing force BF which biases the exterior member 100 in a backward direction which is a direction indicated by an arrow in FIG. 8.

The exterior member 100 is positioned in the up-down direction as a result of the two pins 341 being inserted into the two guide holes 136 and is positioned in the front-back direction FB as a result of the exterior member 100 being biased to the back by means of the biasing force BF, and the exterior member 100 is fixed to the attachment member 300 with the wood screws 15. Here, since the screw hole 340 has a diameter which is sufficiently larger than a shaft diameter of the wood screw 15, even though the exterior member 100 is moved to the back by the biasing mechanism 350, there is no risk of an interference of the wood screw 15 and the screw hole 340. In addition, since the guide hole 136 into which the pin 341 is inserted is formed into the elliptical hole which is long in the front-back direction FB, there is no risk of the backward movement of the exterior member 100 being interrupted by the biasing mechanism 350.

When the exterior member 100 is attached to the attachment member 300 in the way described above, the second exterior surface 120 which constitutes the cut end portion of the exterior member 100 is covered by the corresponding portion of the attachment member 300. That is, as shown in FIG. 2B, when viewed in cross section, a projecting end 313a of the lower surface 313 of the top plate 310 which constitutes a facing surface which faces closely the upper surface 122 which connects to the side surface 111 of the exterior member 100 (in other words, a connecting portion of a side surface with the lower surface 313 of the top plate 310) projects further by a projection amount Ta than the side surface 111 of the exterior member 100. Here, when referred to in the present disclosure, the projection amount means the shortest length which projects outwards (e.g., the right side R in FIG. 2B) of the exterior member 100 from the side surfaces of the exterior member 100 which lies close to the attachment member 300.

Similarly, as shown in FIG. 2C, when viewed in cross section, a projecting end 328a of the upper surface 328 of the bottom plate 324 which constitutes a facing surface which faces closely the lower surface 121 which connects to the side surface 111 of the exterior member 100 projects further by a projection amount Tb than the side surface 111. Similarly, as shown in FIG. 2D, when viewed in cross section, a projecting end 313b of the lower surface 313 of the top plate 310 which constitutes a facing surface which faces closely the upper surface 122 which connects to the front surface 112 of the exterior member 100 projects further by a projection amount Tc than the front surface 112. Similarly, as shown in FIG. 2E, when viewed in cross section, a projecting end 328b of the upper surface 328 of the bottom plate 324 which constitutes a facing surface which faces closely the lower surface 121 which connects to the front surface 112 of the exterior member 100 projects further by a projection amount Td than the front surface 112.

Further, as shown in FIG. 3B, when viewed in cross section, a projecting end 313c of the lower surface 313 of the top plate 310 which constitutes a facing surface which faces closely the upper surface 122 which connects to the back surface 113 of the exterior member 100 projects further by a projection amount Te than the back surface 113. As shown in FIG. 3C, when viewed in cross section, a projecting end 328c of the upper surface 328 of the bottom plate 324 which constitutes a facing surface which faces closely the lower surface 121 which connects to the back surface 113 of the exterior member 100 projects further by a projection amount Tf than the back surface 113.

Here, similar to a facing surface (a side surface on the right side R of the back panel 260 shown in FIG. 3A) which faces the back surface 123 of the exterior member 100 shown in FIG. 6, upper and lower projecting ends of the facing surface at the top plate 310 and the bottom plate 324 both project further than the back surface 113. Similar to a right-hand side surface of the boundary plate 326 shown in FIGS. 2A and 4 which constitutes a facing surface which faces the front surface 124 of the exterior member 100 shown in FIG. 6, upper and lower projecting ends of the facing surface at the top plate 310 and the bottom plate 324 project further than the front surface 112.

As a result, in the case that a finger of a hand or the like of the user reaches the vicinity of the cut end (the second exterior surface 120) of at least any one of the side surface 111, the front surface 112, and the back surface 113 of the exterior member 100, since the projecting ends (the projecting ends 313a, 313b, 328a, 328b, and the like) of the facing surfaces of the second exterior surface 120 constitute an obstacle, there is almost no risk of the finger of the hand of the user touching directly the cut ends (the lower surface 121, the upper surface 122, the back surface 113, the front surface 112) of the exterior member 100, that is, the end portions of the first sheet 70 or the end portions of the second sheet 80, whereby a risk of the first sheet 70 of the first exterior surface 110 or the second sheet 80 of the second exterior surface 120 of the exterior member 100 being turned up is reduced. As a result, the aesthetic external appearance of the keyboard instrument 10 using the pseudo-wood sheet or the like can be maintained.

Here, the projection amounts Ta, Tb, Tc, Td of the projecting ends 313a, 313b, 328a, 328b on the side surface 111 and the front surface 112 are set smaller than the projection amounts Te, Tf of the projecting ends 313c, 328c on the back surface 113. Specifically speaking, the projection amounts Ta, Tb, Tc, Td can be set at about 0.5 mm, and the projection amounts Te, Tf can be set at about 1.0 mm. As a result, the degree of projection as a result of the projection amounts Ta, Tb, Tc, Td on the front side F and the right side R (the left side L) which easily become visible from the user can be made so small that the projections can be hardly recognizable from the user.

Here, the exterior member 100 is attached to the attachment member 300 while being biased to the back by means of the biasing force BF of the biasing mechanism 350, whereby even though the exterior member 100 is formed of MDF which provides a relatively large dimensional error in the front-back direction FB, the projection amounts Tc, Td on the front surface 112 which are set so small as to be hardly recognizable can be secured in an ensured fashion.

For example, even though a front-back dimension of the internal surface 130 which corresponds to the front surface 112 and the back surface 113 is formed larger (longer) than a dimension in the front-back direction FB of the attachment member 300 which corresponds thereto, since the exterior member 100 is biased to the back, the projection amounts Tc, Td can be secured in an ensured fashion. In addition, even though the exterior member 100 is disposed to deviate to the back side B due to the projection amounts Te, Tf on the back surface 113 which are set larger, the projection amounts Te, Tf on the back surface 113 can also be secured in an ensured fashion.

Even though the projection amounts Te, Tf on the back surface 113 are set larger, since the back surface 113 constitutes a location which is not well visible from the user, the projections are hardly recognizable. Since the exterior member 100 made of MDF can be formed accurately in dimension in a plate thickness direction, the projection amounts Ta, Tb on the side surface 111 are easy to be secured.

Thus, according to the embodiment of the present disclosure, the case 200 (the right-hand side case 240) of the keyboard instrument 10 includes the exterior member 100 including the first exterior surface 110 including the external surface of the first sheet 70 and the second exterior surface 120 including the external surface of the second sheet 80 which connects to the first exterior surface 110, and the attachment member 300 to which the exterior member 100 is attached, having the facing surfaces (the lower surface 313 of the top plate 310 and the upper surface 328 of the bottom plate 324) disposed to face the second external surface 120, and arranged in such a manner that the projecting ends (the projecting ends 313a, 313b, 328a, 328b, and the like) of the facing surfaces project further outwards of the case 200 than the first exterior surface 110 when viewed in cross section.

With this configuration, the second exterior surface 120 of the exterior member 100 is covered with the members including the facing surfaces which face the second exterior surface 120, and the projecting ends of the facing surfaces project further than the exterior surface 110 so as to protect the end portions on the first exterior surface 110 which lie on the boundary between the first exterior surface 110 and the second exterior surface 120. As a result, the end portions of the first exterior surface 110 and the end portions of the second exterior surface 120 can be made difficult to be touched by the finger of the hand of the user, whereby the risk of the end portions of the sheets being peeled off can be reduced. Then, the sheets can be prevented from being turned up with the simple structure, whereby the exterior member 100 of a high design quality can be provided by devising the shape thereof, as a result of which the case in which the sheets affixed well to the exterior member 100 are made difficult to be peeled off and the keyboard instrument 10 including this case can be provided.

The attachment member 300 includes the biasing mechanisms 350 configured to bias the exterior member 100 to back or in the backward direction which is one direction. As a result, even though the exterior member 100 is formed of MDF or the like which provides a relatively large dimensional error, the projection amounts Tc, Td can be secured in an ensured fashion. Then, the projection amounts Tc, Td on the front side F can be set relatively small by biasing the exterior member 100 towards the back.

The exterior member 100 is fastened to the attachment member 300 with the screws in the direction perpendicular to the direction in which the biasing mechanisms 350 bias the exterior member 100. As a result, the exterior member 100 can be fixed in an ensured fashion while biasing the exterior member 100.

The plate spring 351 of the biasing mechanism 350 is the resin spring which is provided to be integrated with the attachment member 300. As a result, the biasing mechanism 350 can easily be provided by forming the attachment member 300 (the main body 320) from the resin material.

The first exterior surface 110 has the side surface 111, and the front surface 112 and the back surface 113 which connect to the side surface 111. In the projection amounts Ta, Tb, Tc, Td, Te, Tf, when viewed in cross section, of the projecting ends 313a, 328a, 313b, 328b, 313c, 328c on the lower surface 313 of the top plate 310 and the upper surface 328 of the bottom plate 324 which constitute the facing surfaces disposed to face the second exterior surface 120, the projection amounts Ta, Tb, Tc, Td from the front surface 112 and the side surface 111 are smaller (shorter) than the projection amounts Te, Tf from the back surface 113. As a result, the projection amounts Ta, Tb, Tc, Td on the front side F and the side surface 111 in the left-right direction LR which are easy to be recognizable can be set small (short).

Here, the projection amounts Tc, Td on the front surface 112 are made substantially the same as the projection amounts Ta, Tb on the side surface 111. As a result, the projecting ends 313a, 313b, 328a, 328b provided from the front surface 112 to the side surface 111 are made uniform, thereby making it possible to provide the case 200 as a good looking case.

The first sheet 70 and the second sheet 80 are provided as the pseudo-wood sheets. As a result, the case 200 having the high quality can be provided.

In the embodiment that has been described heretofore, the right-hand side case 240 has been described in detail. However, the embodiment can also be applied to the left-hand side case 230 similarly as applied to the right-hand side case 240. In this case, the exterior member 100 and the attachment member 300 of the left-hand side case 230 are disposed as a structure which is substantially laterally symmetrical with the exterior member 100 and the attachment member 300 of the right-hand side case 240. As a result, the keyboard instrument can be provided in which the sheets which are well affixed to the side exterior members 100 are made difficult to be peeled off.

While the embodiment of the present disclosure has been described heretofore, the embodiment is presented as the example, and hence, there is no intention to limit the scope of the present invention by the embodiment. The novel embodiment can be carried out in other various forms, and various omissions, replacements and modifications can be made thereto without depart from the spirit and scope of the present invention. Those resulting embodiments and modified examples thereof are included in the scope and gist of the present invention and are also included in the scope of inventions claimed for patent under claims below and their equivalents.

What is claimed is:

1. A case comprising:
an exterior member comprising a first surface including an external surface of a first sheet and a second surface connected to the first surface; and
an attachment member to which the exterior member is attached, having a facing surface disposed to face the second surface, and arranged in such a manner that a projecting end of the facing surface projects further than the first surface when viewed in cross section.

2. The case according to claim 1,
wherein the attachment member comprises a biasing mechanism configured to bias the exterior member in one direction.

3. The case according to claim 2,
wherein the biasing mechanism biases the exterior member in a backward direction.

4. The case according to claim 2,
wherein the exterior member is fastened to the attachment member with a screw in a direction perpendicular to a direction in which the biasing mechanism biases the exterior member.

5. The case according to claim 2,
wherein the biasing mechanism is an elastic member which is provided to be integrated with the attachment member.

6. The case according to claim 1,
wherein the first surface comprises a side surface, and a front surface and a back surface which connect to the side surface, and
wherein a projection amount of the projecting end which projects from the back surface is larger than a projection amount of the projecting end which projects from the front surface and a projection amount of the projecting end which projects from the side surface.

7. The case according to claim 1,
wherein the first sheet is a pseudo-wood sheet.

8. A keyboard instrument comprising:
a keyboard; and
the case according to claim 1 which is disposed as an arm of the keyboard.
